(19) United States
(12) Patent Application Publication
(10) Pub. No.: US 2007/0226164 A1
(43) Pub. Date: Sep. 27, 2007

(54) Type variables and/or temporal constraints in plan recognition

(75) Inventors: Christopher W. Geib, Minneapolis, MN (US); Michael J.S. Pelican, Purcellville, VA (US); John A. Phelps, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/386,242

(22) Filed: Mar. 21, 2006

(51) Int. Cl. G06N 7/02

(52) U.S. Cl. 706/52

(57) ABSTRACT

In recognizing plans of agents, the actions of the agents are observed. Based on the observed actions and plans stored in a plan library, a pending set of actions that are pending execution by the agent are generated. Explanations for these pending actions are then generated. The plan library contains plans, the plans stored in the plan library include typed variables and/or temporal constraints, and the explanations depend on the typed variables and/or temporal constraints. Probabilities as to the likelihood that the explanations represent at least one actual plan of the agent may be computed, and at least one of the explanations may be recognized as the actual plan of the agent based on the computed probabilities.

### TECHNICAL FIELD OF THE INVENTION

The present invention relates to plan or intent recognition that is combined with type and/or temporal based reasoning to recognize an agent's plans.

### BACKGROUND OF THE INVENTION

Security measures such as firewalls, cryptography, intrusion detection, network management, and passwords have been used in an attempt to make computer systems more resistant to unauthorized access. But even with these measures, computer systems remain vulnerable to unauthorized intrusions. The list of vulnerabilities of computer systems is large and growing.

In order to mitigate these vulnerabilities, various commercial-off-the-shelf software packages have been developed. However, these packages typically place security as a distinctly secondary goal behind the goals of power and convenience.

Also, there is a trend that relates to the software monoculture typified by attempts at software standardization. However, while it is easier to manage training and installation when all of the nodes of a system are identically configured, node standardization amplifies the risk of unauthorized access. If one node in the system is susceptible to some vulnerability, nearly all of the nodes in the system are likewise susceptible. The success of viruses and worms in bringing corporate networks to a standstill is a recurring demonstration of this weakness.

Many systems, even those using standardized software applications, warrant better security than is offered by current security systems. Current security systems, in a rudimentary way, predict likely outcomes of user commands. These security systems use physical (or other) models to reason out the effect of certain commands on a protected asset.

For example, mathematical models are currently used in “power system security” analysis. That is, the operator of an electric power grid may use a mathematical model of load, power generation, voltage, and current everywhere over the power grid to make sure that planned changes will leave the grid in a stable safe state, even if one or more faults occur. Thus, before a proposed power transfer from point A to point B is implemented, the model simulates various possible line outages that could occur in order to make sure that, in spite of such outages (or planned transfers), the power grid will remain in a stable state (no overloads, blackouts, etc.). A basic reference on this topic is a text entitled “Power Generation, Operation and Control”, by Allen Wood and Bruce Wollenberg.

Moreover, even when current security systems attempt to predict outcomes of user commands, such security systems are not fully integrated so as to anticipate future commands of a user and to consider a range of responses dependent on the level of the threat of future commands. Therefore, there is a need to develop a plan recognition system that increases the level of protection afforded against unauthorized entry and/or use by recognizing the goal or goals of an agent and by taking appropriate action.

Much early work on plan recognition made simplifying assumptions such as an observed agent pursues only a single plan at a time, an observed agent's actions are completely observable, no conclusions can be drawn from failing to see an action, an observed agent never abandons plans, actions within a plan have no explicit temporal relations, and observations are limited and propositional. These assumptions are too restrictive for a plan recognition system to be effectively applied to many domains.

Two kinds of plan recognition, keyhole and intended plan recognition, have been devised and have been distinguished in the literature. In keyhole recognition, the recognition system is simply watching normal actions by an ambivalent agent. In intended plan recognition, the agent is assumed to be cooperative and the agent's actions are done with the intent that they be understood. In neither case is it assumed that the agent is actively hostile to the process of plan recognition, which has limited the usefulness of such systems.

Also, early plan recognition systems were rule-based using inference rules that capture the nature of plan recognition. It was then suggested that plan recognition should be a specific form of the general problem of abduction (reasoning to the best explanation). In 1986, H. Kautz and J. F. Allen, in “Generalized plan recognition,” Proceedings of the Conference of the American Association of Artificial Intelligence (AAAI-86), pp. 32-38, defined the problem of keyhole plan recognition as the problem of identifying a minimal set of top-level actions sufficient to explain a set of observed actions. Plans were represented in a plan graph, with top-level actions as root nodes and expansions of these actions into unordered sets of child actions representing plan decomposition. Accordingly, plan recognition was equivalent to graph covering. The model of plan recognition proposed by Kautz and Allen treated plan recognition as a problem of computing minimal explanations in the form of vertex covers based on the plan graph. A significant problem with the work of Kautz and Allen is that it does not take into account differences in the a priori likelihood of different plans.

It has also been asserted that, since plan recognition involves abduction, plan recognition could best be accomplished as a Bayesian (probabilistic) inference. Bayesian inference supports the preference for minimal explanations, in the case of hypotheses that are equally likely, but also correctly handles explanations of the same complexity but different likelihoods.

Neither of these approaches to plan recognition, however, takes into account the failure to observe certain actions. To do so presents a complex problem. For example, given the plan library of FIG. 1, if the observed actions are consistent with the actions of scan and get-ctrl and if it is assumed that the a priori probabilities of these actions are the same, a plan recognition system should conclude that Brag and Theft are equally good explanations for these actions. However, as time goes by, if the plan recognition system observes other actions that contribute to scan but do not contribute to get-data, the plan recognition system should become more and more certain that Brag rather than Theft is the right explanation.

Unfortunately, prior systems are not capable of this sort of reasoning because they do not consider plan recognition as a problem that evolves over time and they do not consider actions that are not observed.

M. Vilain, in “Deduction as Parsing,” Proceedings of the Conference of the American Association of Artificial Intelligence (1991), pp. 464-470, 1991, presented a theory of plan recognition involving parsing based on the theory of Kautz and Allen. The major problem with traditional parsing as a model of plan recognition is that parsing does not properly treat partially-ordered plans or interleaved plans. Both partial ordering and plan interleaving result in an exponential increase in the size of the required grammar to parse.

More recently, Pynadath and Wellman, in “Probabilistic State-Dependent Grammars for Plan Recognition,” Proceedings of the Conference on Uncertainty in Artificial Intelligence (UAI-'00), pp. 507-514, 2000, proposed a plan recognition schema that is both probabilistic and parsing based. They represent plan libraries as probabilistic context-free grammars and extract Bayesian networks from the probabilistic context-free grammars to interpret observation sequences. Unfortunately, this approach suffers from the same limitations on plan interleaving as Vilain's. Wellman and Pynadath suggest that probabilistic context-sensitive grammars might overcome this problem. However, it is difficult to define a probability distribution for a probabilistic context-free grammar.

Keyhole plan recognition has been suggested for coordinating teams of Procedural Reasoning System (PRS) based agents. Belief networks are automatically generated for plan recognition from PRS knowledge areas (hierarchical reactive plans). However, the generated belief networks for real world problems are too complex for efficient reasoning. It is simpler to work with the plan representation directly. Further, it is not clear how this schema can handle the interleaving of multiple plans and the development of plans over time.

H. H. Bui, S. Venkatesh, and G. West, in “Policy Recognition in the Abstract Hidden Markov Model,” Technical Report 412000 School of Computer Science, Curtin University of Technology, 2002 have proposed a model of plan recognition based on a variant of hidden Markov models. While this model does base its model on plan execution over time, it does not address the case of multiple goals. Like Wellman and Pynadath, the Bui model has to define a probability distribution over the set of all possible root goal sets in order to address multiple concurrent root goals.

Thus, to effectively address plan recognition in adversarial domains, the assumptions that the observed agents will be amenable to observation and inference must be discarded, and the order in which actions are executed must be understood so as to better understand and determine when an agent has multiple goals. Thus, a model of plan execution is needed in which it is recognized that goal driven agents take those actions that are consistent with their goals and that are enabled by the actions that they have already taken. The set of actions that an agent could execute next (i.e., the enabled actions), given their goals, and the actions they have already performed are referred to herein as the pending set. These pending sets may be used by a probabilistic algorithm to recognize plan execution.

Moreover, a plan recognition system should acknowledge that some plans require temporal constraints between their actions and/or that some plans require the variables in the plan library to be further denoted by type.

Plan recognition and related systems are disclosed in the following applications: application Ser. No. 10/286,398 filed Nov. 1, 2002; application Ser. No. 10/303,223 filed Nov. 25, 2002; application Ser. No. 10/339,941 filed Jan. 10, 2003; application Ser. No. 10/341,355 filed Jan. 10, 2003; application Ser. No. 10/348,264 filed Jan. 21, 2003; application Ser. No. 10/444,514 filed May 23, 2003; application Ser. No. 10/703,097 filed Nov. 6, 2003; application Ser. No. 10/703,709 filed Nov. 6, 2003; application Ser. No. 10/830,539 filed Apr. 23, 2004; and, application Ser. No. 11/317,461 filed Dec. 22, 2005. All of these applications are herein incorporated by reference.

The present invention in one embodiment is related to a probabilistic plan recognition model that uses type based reasoning to recognize an agent's plans and/or that permit temporal constraints to be placed on actions in the plan library.

### SUMMARY OF THE INVENTION

In accordance with one aspect of the present invention, a plan recognition method of recognizing a plan based on observed actions is implemented by a processing system and comprises the following: reading the observed actions of at least one agent; based on the observed actions and a plan library, generating a pending set of actions that are pending execution by the agent and generating explanations for the pending actions contained in the pending set, wherein the plan library contains plans, wherein the plans stored in the plan library include typed variables, and wherein the explanations depend on the typed variables; computing probabilities as to the likelihood that the explanations represent at least one actual plan of the agent; and, recognizing at least one of the explanations as the actual plan of the agent based on the computed probabilities.

In accordance with another aspect of the present invention, a plan recognition method of recognizing a plan based on observed actions is implemented by a processing system and comprises the following: reading the observed actions of at least one agent; based on the observed actions and a plan library, generating a pending set of actions that are pending execution by the agent and generating explanations for the pending actions contained in the pending set, wherein the plan library stores plans, wherein the plans contain actions, wherein the actions contained in the plans stored in the plan library include temporal constraints between actions, and wherein the explanations depend on the temporal constraints; computing probabilities as to the likelihood that the explanations represent at least one actual plan of the agent; and, recognizing at least one of the explanations as the actual plan of the agent based on the computed probabilities.

In accordance with yet another aspect of the present invention, a computer readable storage medium has program code stored thereon which, when executed, performs the following plan recognition functions: reading the observed actions of at least one agent; comparing the observed actions to plan actions contained in plans stored in a plan library; generating explanations for the observed actions based on the comparison of the observed actions to plan actions, wherein the explanations must satisfy typed variables and temporal constraints stored in the plan library; selecting at least one of the explanations as a best fit for the observed actions; and, providing an output based on the selected explanation.

In accordance with still another aspect of the present invention, a plan recognition method, implemented by a processing system, of recognizing a plan based on observed actions comprises the following: reading the observed actions of at least one agent; comparing the observed actions to a plan library contains possible plans of the agent, wherein the plans stored in the plan library include typed variables or temporal constraints relating to statements in the plans; and, recognizing a plan of the agent based on the comparing of the observed actions to the plan library and on the typed variables or temporal constraints.

### BRIEF DESCRIPTION OF THE DRAWINGS

These and other features and advantages will become more apparent from a detailed consideration of the invention when taken in conjunction with the drawings in which:

FIG. 1 illustrates an example of a set of plans that may be stored in a plan library of a plan recognition system;

FIG. 2 illustrates the generation of pending sets of actions related to plans in the plan library;

FIG. 3 shows substitution of a new tree for a non-terminal node in an existing tree;

FIG. 4 shows one possible explanation for the sequence of observations (zt,t1), (ips,t2), (zt,t3), (ps,t4), (pod,t5) given the plan library shown in FIG. 1;

FIG. 5 shows a plan recognition system in accordance with an embodiment of the present invention; and, FIG. 6 shows a flow chart of a plan recognition program that can be executed by the plan recognition system of FIG. 5 in order to explain observed actions.

### DETAILED DESCRIPTION

The plan recognition system described herein is based on a model of the execution of hierarchical plans rather than of plans as formal models of syntactic entities. This different modeling approach gives rise to different intuitions about how plans should be recognized. Plan recognition algorithms typically require, as an input, a set of plans that are to be recognized. Example formal definitions for such plans are provided below, although for purposes of discussion it is convenient to discuss such plans with a less formal representation as partially ordered “and/or” trees having “and nodes” and “or nodes,” where the children of the “and nodes” may be partially ordered.

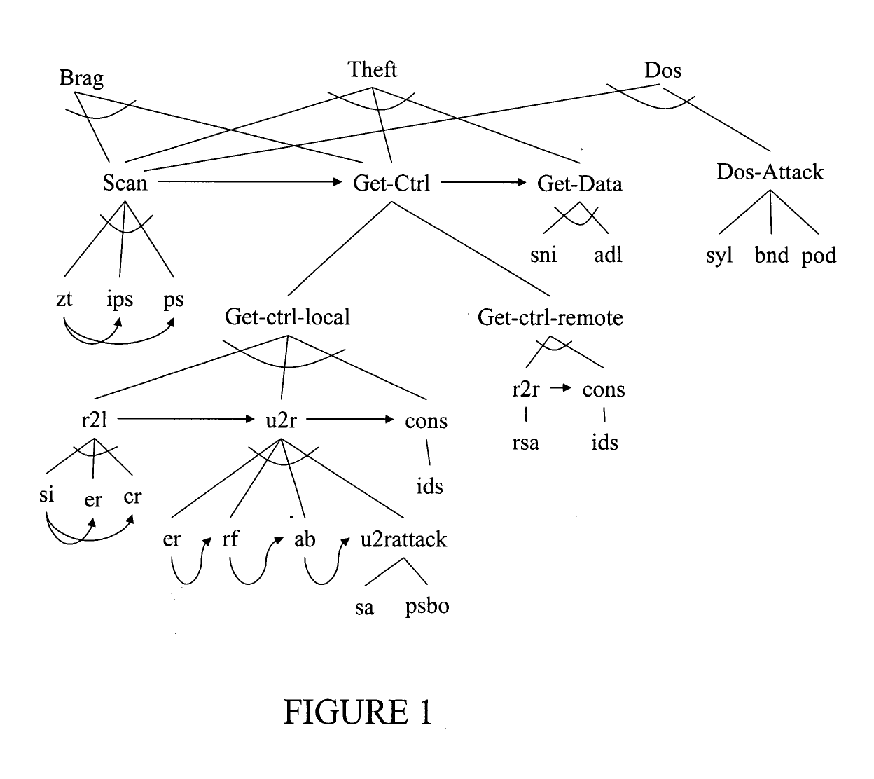

As an example, FIG. 1 displays a simplified set of hierarchical plans taken from a computer network security domain. The trees of FIG. 1 define a decomposition of root goals (Brag, Theft, Denial of Service) into sequences of sub-actions that will achieve the root goals. Such a decomposition is indicated in FIG. 1 by a straight solid line from a parent node to each of its children nodes. If all of the sub-actions must be done to achieve the parent goal, the parent goal is represented as an “and node” in the tree, and is illustrated in FIG. 1 by an arc crossing all of the links from the parent to the children. In many cases, the sub-steps (sub-actions) of an “and node” must be done in a particular order. Ordering constraints between such sub-actions that are necessary to achieve a goal are represented by directed arcs (arcuate arrows) in the plan graph of FIG. 1. However, certain actions of a particular plan graph may not be ordered with respect to each other. Moreover, if the sub-actions are alternative sub-actions, the parent goal is represented as an “or node” in the tree, and is illustrated in FIG. 1 by no arc crossing the links from the parent to the children.

According to this simplified set of hierarchical plans as shown in FIG. 1, the agent (in this case an attacker) is motivated by one of three top-level goals: bragging (Brag: being able to boast of his/her success to other hackers); theft of information (Theft); or denial of service (DoS: attacking a network by consuming its resources so that it can no longer serve its legitimate objectives).

According to the plans represented by the graphical plan library of FIG. 1, attackers who wish to achieve bragging rights will first scan the target for vulnerabilities (scan), and then attempt to gain control (get-ctrl). They are not motivated by exploiting the control they gain. On the other hand, attackers who wish to steal information will scan for vulnerabilities, get control of the target, and then exploit that control to steal data (get-data). Finally, an attacker who wishes to deny service (DoS) to users of a host need only scan to identify a vulnerability and then carry out the DoS attack (dos-attack).

FIG. 1 contains a simple plan for scanning. First, a Domain Name Service (DNS) zone transfer (zt) is requested to identify IP addresses in the target. Then an IP sweep (ips) of the detected addresses and a port sweep (ps) are made in no particular order.

The next step is for the attacker to gain control of the host (i.e., to achieve privileged (“root”) access to that host) in order to be able to execute administrative commands. Attackers may attack either remotely (get-ctrl-remote) or locally (get-ctrl-local). The remote attack is simpler, consisting only of a remote to root (r2r) exploit which allows an attacker who is not directly logged into a host to fool that host into being accorded root privilege. While such attacks are simpler, the underlying exploits are less common, because they rely on flaws in network server software. Only one r2r attack is shown in FIG. 1, i.e., remote sadmind attack (rsa). This exploit is followed by consolidating (cons) the attacker's advantage by turning off the local intrusion detection systems (ids).

Attacking locally, i.e., get-ctrl-local, is more complicated, since the attacker must first gain local access (login) from his/her original remote location (r2l), escalate his/her unprivileged access to root level (u2r), and consolidate his/her position, in that order. In this case, the r2l attack is an IP masquerading attack. An IP masquerading attack is an attack in which the attacker makes the attacker's computer “masquerade” as a trusted host while connecting to the target. To successfully carry out this masquerade, the trusted host being impersonated is suppressed with a DoS attack (si) followed by corruption of an rhost file (cr) and an external rlogin (er) in either order.

In the escalating privilege step (u2r), the plan captures the possibility that an attacker might download the source for an attack and compile it locally. In this plan, the cracker logs in (er), then uses the FTP protocol to transfer source code for an exploit that will run locally (rf), then builds the exploit application (ab), and finally performs the actual attack using the exploit application (u2rattack). Only two of the possible u2rattack expansions are identified here: an sadmindex attack (sa) and ps buffer overflow (psbo).

In the case of a dos-attack, three of the many possible attacks are identified here: synflood (syl), bind DoS attack (bnd), and the ping of Death (pod).

The plans shown in FIG. 1 include a variety of the phenomena that are of interest for this domain. The plan set reflects both the plans that are of interest as well as specific domain features of interest. However, the domain expert will want to add more plans to this plan library using the structure of FIG. 1, especially as more such plans are experienced and/or envisaged. In any event, this set of plans is sufficient to demonstrate the plan library used by the plan recognition system described herein. It can also be generalized to other domains. Some important features of these plans are that they make use of decomposition (represented by “and nodes”), choice points (represented by “or nodes”), and ordering constraints between sibling actions that represent causal links (represented by arcuate arrows).

Plan recognition as described herein implements a Bayesian approach, which relies on a stochastic model that describes how a set of observations are generated from causal variables, and that is then “inverted” to go from observations to hypotheses about underlying causes. In the case of plan recognition, this procedure amounts to providing a stochastic model of plan execution and then “inverting” that model to do plan inference.

The plan recognition model described herein realizes that plans are executed dynamically and that, as a result, the actions that an agent takes at each time step of a plan depend on the actions that were previously taken. Intuitively, at any moment, the agent may wish to execute any of the actions that will contribute to one of the agent's current goals. However, the agent can only successfully execute those actions that have been enabled by prior execution of predecessor actions in the plan. The set of actions that contribute to the agent's current plans and that are enabled by their previous actions are referred to herein as a pending set. The pending set contains the actions that are “pending” execution by the agent.

A model of plan execution can be built with this idea in mind. First, an agent chooses and/or has a set of goals, and the agent chooses a set of plans to achieve the goals. Before the agent acts, there is a subset of primitive actions in the plan that has no prerequisite actions in the plan. The primitive actions in this subset form the initial pending set for the agent. From this initial set, the agent chooses a first action for execution.

After this action has been performed, the agent's pending set is changed. Some actions may be removed from the pending set (the action that was just executed for example) and other actions may be added to the pending set (those actions that are enabled by the execution of the previous action). As the agent chooses a next action from the current pending set, a new pending set is generated, and the process of choosing an action and building new pending sets repeats until the agent stops performing actions or finishes all plans.

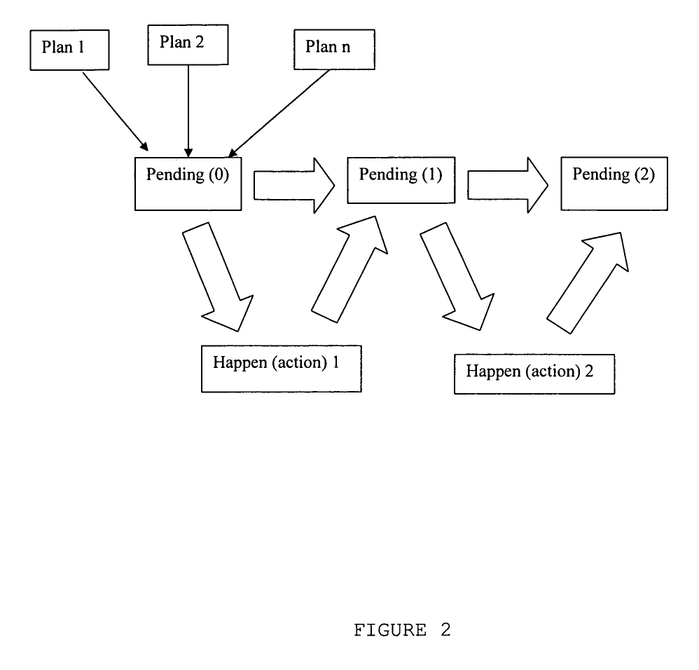

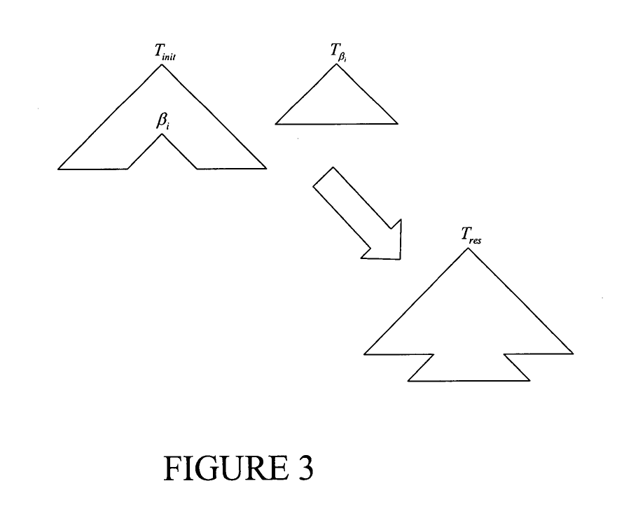

This process is illustrated in FIG. 2 where each action results in a new pending set. If the selection of goals, plans, and actions for execution are probabilistically modeled, the pending sets are a Markov chain, and this probabilistic model of plan execution is a hidden Markov model (HMM) because the observer cannot see the agent's goals, choices at the “or nodes” in the plans, or the pending sets.

The process of plan execution can be probabilistically simulated by sampling the agent's goals and plans, and then repeatedly choosing elements from the resulting pending sets, thus generating future pending sets. This approach provides a simple model for the generation of execution traces. For each execution trace, there is a unique corresponding sequence of pending sets.

To use this model to perform probabilistic plan recognition, the observations of the agent's actions are used as execution traces and the generation process is inverted to build an explanation for the observed actions. By hypothesizing goals and plans for the agent, and then stepping forward through the observation trace, a possible pending set trajectory can be generated. As the explanation is built, each observed action is assigned to hypothesized plans that achieve the hypothesized goals of the agent. Thus, the pending set trajectory that is consistent with the observed actions can be determined.

Once the complete set of explanations is built, the probability of each explanation can be computed. Keeping in mind that the plan recognition system utilizes a Bayesian approach, the probability Pr(exp|obs) of a particular explanation exp given a set of observations obs can be computed using Bayes' rule as follows:
Pr(expˆobs)/Pr(obs)
which has the equivalent formulation as follows:

$$Pr ( exp ⋀ obs ) / {\sum }_{i} Pr ( {exp}_{i} ⋀ obs )$$

Specifically, since the probability of a single explanation can be computed, the conditional probability of an explanation and, therefore, the conditional probability for any particular goal can be computed by building the complete set of possible explanations for the observations, computing their probabilities, and dividing the probability mass associated with those explanations that contain the goal by the probability mass associated with all explanations.

A more formal definition for this process can be provided as discussed below. First, explanations and pending sets can be formulated based on a plan library and tree structures in a manner very similar to the definitions for traditional context-free grammars suggested by J. E. Hoperoft and J. D. Ullman, in Introduction to Automata Theory, Languages, and Computation, Addison Wesley, 1979, but extending them to handle partial ordering of actions. In this context, partial ordering of the plans actions means that ordering constraints between the actions are not required. While some of the actions must be done in a specific order with respect to each other, others of the actions may vary in their order. For example, putting on socks must be done before putting on shoes. Thus, putting on socks and shoes are ordered with respect to each other in the higher level action of putting them on. However, in buying socks and shoes in the same store, the order in which they are chosen is unimportant, but would both happen before leaving the store. In this case, picking out the shoes and socks are partially ordered with respect to each other, but are both ordered before the action of leaving the store.

Second, the manner in which probabilities are computed for each of these explanations and the manner in which conditional probabilities are computed for each goal are described.

The foundation of any plan recognition system is a collection of plans for recognition. These plans can be stored in a plan library and may be specified according to one embodiment, in a formal language as set out in definitions 1-5 below.

Definition 1—A plan library PL is defined as a tuple PL=(Σ, NT, R, P) where Σ is a finite set of basic actions or terminal symbols, NT is a finite set of methods or non-terminal symbols, R is a distinguished subset of “intendable root” non-terminal symbols R⊂NT, and P is a set of production rules of the form A→α:φ where
1. A∈NT
2. α is a string of symbols from (Σ∪NT)
3. φ={(i,j)|α[i] [symbol] α[j]} where α[i] and α[j] refer to the ith and jth symbols in α, respectively.
   Intuitively, this definition is a traditional context-free grammar except for the addition of explicit ordering constraints, defined by the relation [symbol] , that are added to each of the productions of the grammar to indicate when actions must be performed in a specific order. By contrast, traditional context-free grammars assume that ordering of symbols indicates a required ordering in the plan. In a traditional context-free grammar, partial ordering is represented by replicating those rules that contain partial ordering, one production for each of the possible orderings for the actions. This replication results in a significant increase in the size of the plan library.

In FIG. 1, the terminal symbols correspond to the names given to the leaves in the trees in the plan library. The non-terminal symbols correspond to the names of the “and nodes” and “or nodes.” The productions in this formulation of a plan library correspond to “and nodes” in the plan tree shown in FIG. 1. “Or nodes” in FIG. 1 are captured when there is more than one production for a non-terminal. For example, the following example plan library productions:
Theft→scan get-ctrl get-data: {(1,2)(2,3)}
scan→zt_ips_ps: {(1,2)(1,3)}
get-ctrl→get-ctrl-local: { }
get-ctrl→get-ctrl-remote: { }
get-data→sni_adl: { }
   capture the first two levels of the plan for Theft shown in FIG. 1 with the two rules for get-ctrl capturing the “or node.”

Definition 2—Given a rule ρ=A →β:φ, β[i] is a leftmost child of A given ρ if [symbol] j such that (j,i) ∈ φ.

The set of leftmost symbols for a given rule allows those symbols to be first in any expansion of the parent non-terminal by that rule. This definition does not require that there be a unique leftmost symbol of a rule, and the set of such leftmost symbols is denoted as L(ρ) and the set of symbols that are not left most symbols of ρ is denoted as R(ρ).

Definition 3—Given a plan library PL=(Σ, NT, R, P), a leftmost tree T, deriving α, can be defined as a tree such that
1. every node in T is labeled with a symbol from Σ∪NT.
2. every interior node in T is labeled with a symbol from NT.
3. if an interior node, n, labeled A in T has children with labels β₁, . . . ,βₖ, then
   ∃β∈P|ρ=A→β₁, . . . ,βₖ:φ
   node n is additionally annotated with ρ
   no children of n labeled with symbols in R(ρ) have children.
   at most one child of n labeled with a symbol in L(ρ) has children of its own.
4. there is a distinguished node in the frontier of T labeled with the terminal symbol α. This node is the foot of the tree T.

Leftmost trees correspond very closely to minimal, leftmost, depth-first, derivation trees for a specific terminal in traditional context-free grammars. In this case, the ordering relation defined for the plan library is used to determine which methods/non-terminals are leftmost. The leftmost trees are used both to build explanations and as elements of pending sets by first defining a generating set of trees for a particular plan library and then defining the process by which the trees are composed to produce explanations of sequences of observations.

Definition 4—A set of leftmost trees is said to be generating for a plan library PL=(Σ, NT, R, P) if it contains all of the leftmost trees that derive some basic action in Σ rooted at a method in NT. The generating set is denoted as G(PL) and its members are denoted as generating trees.

Substitution is used to combine the trees in the generating set to build larger trees. Substitution is the process whereby a frontier non-terminal in an existing tree is replaced with a leftmost tree that is rooted with the same non-terminal symbol while obeying the ordering constraints defined by the plan library.

Definition 5—Given a tree Tᵢₙᵢₜ with a frontier, non-terminal node m, and assuming node n to be m's parent node, and assuming without loss of generality that n is labeled A and is annotated with the rule A→β₁, . . . ,βₖ:φ and that m is labeled βᵢ, and further given a leftmost tree whose root is labeled with βᵢ and is denoted T_{βi}, T_{βi} can be substituted for m in Tᵢₙᵢₜ resulting in Tᵣₑₛ just in the case that, ∀j,i|(j,i)∈φ, the frontier of the subtree of Tᵢₙᵢₜ rooted at n's child labeled βⱼ only contains terminal symbols, and that Tᵣₑₛ is the tree that is obtained by replacing βᵢ by T_{βi}.

FIG. 3 shows an abstract example of substitution in graphical form where T_{βi} is substituted for a node in Tᵢₙᵢₜ to form Tᵣₑₛ.

In order for a new tree T_{βi} to be substituted for a non-terminal node m in an existing tree Tᵢₙᵢₜ, the portion of the frontier of the existing tree Tᵢₙᵢₜ that is required by the plan library PL to precede the substitution site m cannot have non-terminals. That is, the portion of the existing tree's frontier that precedes the substitution site must be completely expanded (contain only terminal symbols/basic actions). This definition of substitution is similar to tree adjunction as presented by A. Joshi and Y Schabes, in “Tree-Adjoining Grammars,” Handbook of Formal Languages, Vol. 3, pp. 69-124, Springer Verlag, 1997, again with the introduction of ordering constraints.

The above definitions 1-5 define a plan library and the tree structures that follow from it. The next two definitions 6 and 7 define pending sets.

Definition 6—The initial pending set PS₀⊂G (PL) is defined such that, PS₀=(∀T∈G(PL), root(T)∈R).

The label root(T) denotes the root node of the tree T. Intuitively this set of trees corresponds to those leftmost trees in the generating set that derive an action that could introduce a new plan. That is, these trees all derive the first action of a plan rooted in one of the distinguished intendable root non-terminals. The initial pending set plays an important role in the discussion herein, all other pending sets are defined as derived from a set of existing trees.

Definition 7—Given a plan library PL and a set of partially expanded trees D representing plans from PL, the pending set for D is defined as the set of all trees T∈G(PL) that can be substituted into some tree in D.

A pending set can contain multiple instances of a given generating tree. Thus, definition 7 does not prevent a particular generating tree from being substituted into multiple points in different (or even the same) tree in D. Therefore, the pending set is required to maintain a separate instance for each generating tree indexed by the tree and non-terminal for which it will be substituted.

It is also worthwhile to note that the initial pending set is a subset of every pending set. Since the next observed action could be the first action of a previously unobserved plan, each of these trees is in every pending set.

Given definitions 1-7, explanations and the process of generating them can be formally defined. Intuitively, an explanation for a set of observations is just a pair that contains a forest of trees representing a plan structure that allows for the assignment of each observation to a terminal symbol, called the derivation trees, and the sequence of pending sets that were used in the production of the particular derivation trees. Definition 8 formulates the process of generating explanations.

Definition 8—An explanation is defined for a sequence of observations, σ₁, . . . ,σₙ, as a pair, <D, {PS₀, . . . , PSₙ₊₁}>, where D is a possibly empty forest of derivation trees, and {PS₀, . . . , PSₙ₊₁} is the series of pending sets derived in the construction of D. In order to actually produce a particular explanation, the following algorithm is specified for generating a new explanation on the basis of an existing explanation. Given an observation σ∈Σ, given a plan library PL, and given an explanation Eₙ=<D, {PSo, . . . PSₙ}>, a new explanation Eₙ₊₁ can be generated by executing the following steps:
1. Choose from PSₙ, a tree T_{new} that can be substituted into T_{cur} ∈D such that the foot of T_{new} matches σ.
2. Substitute T_{new} into T_{cur} resulting in Tᵣₑₛ.
3. Define D′=(D−T_{cur})∪Tᵣₑₛ.
4. Generate the new pending set PSₙ₊₁ for D′.
5. Define Eₙ₊₁=<D′, {PS_{O}, . . . , PSₙ, PSₙ₊₁}>

Given the algorithm above for building one explanation from another, the algorithm for building an explanation for a sequence of observations can be provided. Given a plan library and a sequence of observations σ₁, . . . ,σₙ, the starting point is an initial explanation E₀ that is made up of an empty set of derivation trees and the initial pending set for the plan library. The explanation generation algorithm is then applied for each of the observations in turn until the complete and covering set of explanations for all of the available observations is generated. The following pseudocode explains this process:

```
Function BuildExplanations (σ₁,...,σₙ) {
ES = {E₀};
  For each observation σ in (σ₁,...,σₙ)
    ES' = ;
    For each Eᵢ ε ES such that Eᵢ = < D, {PSo,...PSn} >
      For each T_{new}εPSₙ such that the foot of T_{new} = σ
        Substitute T_{new} into D resulting in D';
        Update PSₙ resulting in PSₙ₊₁;
        ES' = ES' ∪ {< D',{PS₀, . . ., PSₙ, PSₙ₊₁ >}};
      End-for;
    End-for;
    ES = ES';
  End-for;
return ES;}
```

When this algorithm terminates, ES contains the complete set of explanations.

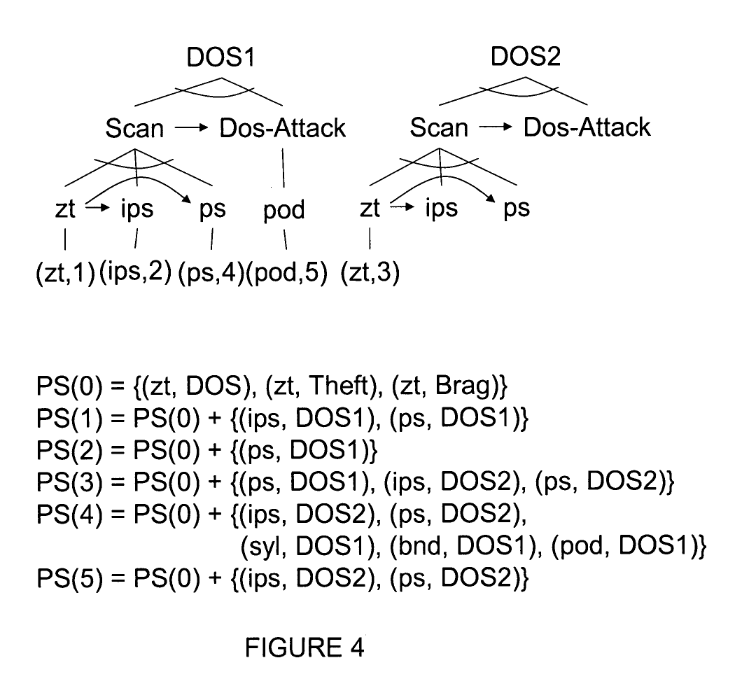

For example, given the plan library shown in FIG. 1, one possible explanation for the sequence of observations (zt,t1), (ips,t2), (zt,t3), (ps,t4), (pod,t5) is shown in FIG. 4, where t1, t2, t3, t4, and t5 are sequential instants in time.

The “for” loops require the algorithm to consider all of the possible elements in the pending set of explanations that correspond to the next observation. Thus, if there are multiple elements in the pending set that have the observed action as its leaf, then the search for explanations splits at this point producing one explanation for each of the possible explanations for the observation and adds all of them to the set of explanations ES.

Also, if there are no elements of the current pending set that make use of the observation, then the current explanation is not extended with the observation and is actually removed from the set of explanations. In other words, since there is no explanation for the action, there cannot be a complete and consistent explanation for all of the observations that results from extending this explanation and there is no point in continuing to use it as a basis for explaining the observations.

This algorithm is used to build a complete and covering set of explanations for a set of observations. Then, the probability of each explanation in this set is established. On the basis of these probabilities, the conditional probability that the agent is pursuing any particular goal can be determined.

The probability of an explanation can be computed by considering three kinds of probabilistic features for each of the explanations for the observations.

The first probabilistic feature is the prior probability of each of the root goals being adopted by the actor. This probability is given in the plan library and is represented as Pr (Gᵢ) where i ranges over all the root goals in the explanation.

The second probabilistic feature is related to the choice that the agent has at each “or node” in the plan tree. For each non-terminal (“or node”) for which there are multiple production rules, each given rule used to expand the non-terminal should have a probability. An “or node” represents a choice for the actor and the plan recognition system should probabilistically model that choice. For example, if a cyber attacker could use a land, synflood, or POD for a denial of service attack, the plan recognition system should have a distribution over how likely each of these possible attacks is given that the agent is going to commit a denial of service attack. Each non-terminal within a plan that has more than one possible rule may be referred to as a choice point.

It may be assumed that each rule is equally likely given its parent goal. Accordingly, if there are J choice points within a given explanation, and if |Chⱼ| represents the number of alternative rules that could be used to expand a particular choice, then 1/|Chⱼ| represents the probability of the agent choosing any particular rule. It should be noted that the assumption that each rule is equally likely given its parent goal is not required by the framework described herein. Any distribution over these choices could be used in place of this assumed uniform distribution.

The assumption that each rule is equally likely is by way of example only. Indeed, some domains will require different likelihoods for different rules.

The third probabilistic feature is the probability that, for each pending set PS, the observed action is the one chosen next for execution. Again, it may be assumed that all of the actions within the pending set are equally likely. Thus for a particular pending set at time k, the probability of any specific element of the set is given by 1/|PSₖ|. Again, this uniformity assumption is not required, and any other distribution could be chosen. This choice could even be conditioned on the state of the world, hypothesized root goals, and plans of the agent.

Using these three probabilistic features, the prior probability of a given explanation may be computed by multiplying together the prior probabilities for each goal, the probability of the expansion choices, and the probability of the observed actions being chosen. The probabilities corresponding to these three probabilistic features are defined according to Definitions 9-10.

Definition 9—The probability of a given explanation is computed according to the following equation:

$$Pr ( exp , obs ) = {\prod }_{i = 0}^{I} Pr ( {G}_{i} ) {\prod }_{j = 0}^{J} ( \frac{1}{\vert {Ch}_{j} \vert} ) {\prod }_{k = 0}^{K} ( \frac{1}{\vert {PS}_{k} \vert} )$$

where the first term is the probability of the agent's goal set, the second term is the probability that the agent chose the particular plans to achieve the goals, and the final term captures the probability that the given observations occurred in the specified order. As discussed above, Pr(Gᵢ) is the prior probability given in the plan library for the root goal of explanation i for the observed actions of the agent, |Chⱼ| represents the number of alternative rules that could be used to expand a particular one of the j choice points within a given explanation, and PSₖ is the size of the explanation's pending set at time k.

Since, the set of explanations is, by construction, an exclusive and exhaustive covering for the set of observations, these computed probabilities for each explanation can be normalized to yield probabilities for each explanation.

As indicated in Definition 10 below, conditional queries can be computed by summing the probability mass for those explanations that meet the terms of the query and dividing by the total probability mass associated with all explanations that contain the goal.

Definition 10—The probability that an agent intends a particular goal g based on a set of observations is given by the following equation:

$$Pr ( g \vert obs ) = \frac{{\sum }_{e}^{{Exp}_{g}} Pr ( e , obs )}{{\sum }_{e}^{Exp} Pr ( e , obs )}$$

where the denominator sums the probability of all explanations, Exp, for the observations, and the numerator sums the probability of the explanations, Exp_{g}, in which the goal g occurs. A misconception that could be made is that the denominator in this equation should always be one, making this division unnecessary. In fact, the probability mass of the covering set of explanations Exp almost never sums to one as a result of multiple independent root goals and the choices within an explanation.

Other known probabilistic plan recognition systems do not use the three different probabilities discussed above. Most probabilistic context free (and sensitive) grammar (PCFG/PCSG) research has included the use of a single probability for each grammar rule to capture how likely it is that the given non-terminal is expanded using that grammar rule. As a structural relation, this use of a single probability conflates the probabilities that are identified above as the root priors and the choice terms in Definition 9. The use of a single probability also completely leaves out the term for the pending sets, making it impossible for known probabilistic grammars to deal with partial observability, partially ordered plans, and/or multiple concurrent plans.

The plan recognition system described herein can also be arranged to account for the effect of negative evidence (actions that have not been observed). In fact, the use of unobserved actions by the present plan recognition system is a natural consequence of the way in which the probabilities are computed for the pending set term for each explanation.

For example, suppose that there are two explanations for a given set of observations. Further suppose that the set of root goals for one is {A,C}, that the set of root goals for the other is {B,C}, that A is a proper prefix of B, that D represents the suffix of B not in A, and that both explanations have identical assignments of observations to plan actions up until goal A is completed. In terms of the probability that can be computed for each of the two explanations, once the last action in goal A has occurred, the probability that can be computed for the pending set {A,C} must be smaller than the probability that can be computed for the pending set {B,C} because the {A,C} pending set can only have actions for goal C while, in the case of the {B,C} pending set, the actions that make up goal D are still in the pending set. Based on the uniformity assumption discussed above, the probability computed for the pending set {B,C} decreases each time an action that is not associated with goal D is observed because the pending set size increase with each action.

Of course, if an action consistent with goal D is observed, the explanation must be changed. In the case where observed actions contribute to the goal D, the {A,C} explanation must be ruled out since it cannot explain the action. Thus, the remaining {B,C} explanation, no matter how unlikely, must be correct.

As discussed above, the approach to plan recognition described herein also allows for multiple instances of the same root goal to be active at the same time, which is unusual for plan recognition systems. In fact, many applications do not allow an agent to have more than one goal at a time let alone multiple instances of the same goal. However, for many real world domains, permitting an agent to have only one goal at a time is simply unacceptable.

For example, in the cyber security domain of FIG. 1, it is common for a determined cyber attacker in the real world to launch against a single host multiple different attacks, and even multiple instances of the same attack, all to achieve a single goal. This method of attack is done for a number of reasons: diversity of target susceptibility, attack success likelihood, to create confusion, etc. Thus, in this domain it is very common to see multiple instances of the same goal being pursued by different, very similar, or even identical instances of plans. The explanation presented in FIG. 4 has remained agnostic about the specific Dos-Attack that will be launched (as it should according to the definition of an explanation set out herein). However, since the action zt observed at time t3 is consistent with a second DoS goal, any complete plan recognition algorithm should consider the possibility that there are multiple interleaved instances of this goal being pursued by a single agent at the same time.

Most, if not all, previous work has discounted the possibility that a single agent could be pursuing multiple instances of the same root goal at the same time. However, in many domains of interest, this assumption is required.

Explanations were defined above in a manner that is very similar to a parse tree for context-free grammars (with the addition of pending sets). Conventional context-free grammars for natural language processing are often annotated with features to carry along the extra information that is needed for the parsing of the sentence and to allow for the construction of a structure representing the semantics of the sentence. Such features allow for validating number and tense agreement and other syntactic properties. The plan recognition system described herein makes use of a very similar capability to bind observational arguments and temporal relations between observations.

The plan recognition system described herein does support arguments for observations and plans. Rather than supporting a full blown first order representation of plans, variables are closer to simple place holders that support propagation and co-reference, which is very similar to the features like number and case that are sometimes included in context-free grammars for natural language parsing and that are bound at parse time. To do this, the plans within the plan library are augmented with variables and optional type specifications for these variables.

The arguments within a plan are implicitly existentially quantified, and the use of a common name denotes co-reference within a given plan definition. Variable bindings will propagate upwards from their introduction in observations to higher levels of abstraction in the plans.

The following method definition taken from a plan library for a simple domain for recognizing when a child is being taken to school can be considered. The def-precond statements define the ordering constraints on the actions in this method.

```
(def-method \grave{ }(taking-child-to-school child)
    \grave{ }((put-in-vehicle child vehicle)
      (drive-vehicle-to-school vehicle)
      (take-from-vehicle child vehicle)
      (go-into-school child)
(def-precond 2 \grave{ }(1))
(def-precond 3 \grave{ }(2))
(def-precond 4 \grave{ }(3))
(endm)
```

In this definition, the “taking-child-to-school”, action has one argument, child. Further, all of the actions in the decomposition make use of the arguments child and/or vehicle. Both child and vehicle are assumed to denote variables, and all references to the same variable name within a single action definition (root, method, choice, or leaf) are assumed to co-refer.

In building the explanation structure for a specific observation of a put-in-vehicle action, the child and vehicle variables are bound together and the bindings are propagated both up the structure to the “taking-child-to-school” action and to other occurrences of the variables in later actions in the method. To enable this propagation, any arguments to the action being defined in a method or choice definition are expected to occur in at least one of the sub-actions of the definition. If the variable does not occur in a lower level action, it will not be bound by observations and, therefore, will be left unbound in generated explanations.

Once the variables are bound by observations within a single explanation, later observations with conflicting variable bindings may be inconsistent with the bindings within the explanation, which may mean that some explanations for the observations are discarded. Therefore, correct binding and propagation of variables provide additional constraints on those explanations that are consistent with the observations. Thus, this simple form of observation driven variable binding and propagation can result in significant reductions in search space.

With the reductions from inconsistent variable bindings in mind, adding type constraints to variables enables further reductions in the set of consistent explanations. To this end, the variables should allow the specification of the type of object that can be bound to a specific argument. For example, the previous example can be extended with the following variable type definitions:
(def-var-type :vehicle)
(def-var-type :car :vehicle)
(def-var-type :aircraft :vehicle)
(def-var-type :young-human)
(def-var-type :school-aged :young-human)
(def-var-type :infant :young-human)
   The plan language used in the plan library can be extended to define the specific typed variables used in the domain. Extension of the plan language can be implemented in two steps.

First, the plan domain definition can be extended with a method of defining the root variables type to be used in the domain and in any subclass relationships between different types. In the present plan recognition system, the def-var-type command is used for this task.

To indicate that a given type is a root type, the def-var-type command is used with only a single argument. The argument is defined as a reserved word and can be used by the type system. For example, :vehicle and :young-human are both root types.

Def-var-type commands with two arguments both define a new type and specify that the new type is a subclass of a previously existing class. For example, :car and :school-aged represent subclasses of :vehicle and :young-human respectively.

Beyond defining the types and their relations, the language of the plan library needs to be extended to allow the specification of types for each argument. This language extension is done by the addition of a simple extension to the plan language with a :type delimiter. In our previous example the :type delimiter may be used as follows:

```
(def-method
  \grave{ }(taking-child-to-school (child :type :school-aged))
    \grave{ }((put-in-vehicle (child :type :school-aged)
        (vehicle :type :car))
      (drive-vehicle-to-school (vehicle :type :car))
      (take-from-vehicle (child :type :school-aged))
        (vehicle :type :car))
      (go-into-school (child :type :school-aged))))
(def-precond 2 \grave{ }(1))
(def-precond 3 \grave{ }(2))
(def-precond 4 \grave{ }(3)
(endm)
```

This definition restricts the previous example so that the child could only be bound to a child of school age and so that vehicle could only be bound to on-the-road passenger vehicles, which allows the taking of a new born to school or using aircraft to go to school to be ruled out.

A type inference system may be used to check for consistency of the variables, and the plan representation language can be arranged to allow for the specification of types and type hierarchy consistent with the type inference system.

The type inference system, although used for action arguments, more generally can be used to provide a formal method of restricting the domain entities that can be bound to an argument of a given action. As such, there are two important design criteria that may be considered, efficiency and flexibility. Efficiency is important because plan inference is an expensive operation and because adding arbitrary reasoning about possible arguments is generally unacceptable. Therefore, plan recognition algorithms should be efficient. Also, different domains have different requirements such as reasoning about class/sub-class relationships, reasoning about properties of arguments, and multiple inheritance among others. Therefore, the plan recognition system needs to be flexible to accommodate different domains.

Further, the type system of the present plan recognition system supports simple negation of types to allow a domain designer to specify the type of object that cannot be bound to a specific variable. This type negation may be implemented through the keyword :not in the type definition. As an example, the previous definition could be generalized to indicate that one cannot use aircraft to take a child to school, as given by the following:

```
(def-method
  \grave{ }(taking-child-to-school (child :type :school-aged))
    \grave{ }((put-in-vehicle (child :type :school-aged)
        (vehicle :type :not :aircraft))
      (drive-vehicle-to-school
        (vehicle :type :not :aircraft))
      (take-from-vehicle (child :type :school-aged))
          (vehicle :type :not :aircraft))
      (go-into-school (child :type :school-aged))))
(def-precond 2 \grave{ }(1))
(def-precond 3 \grave{ }(2))
(def-precond 4 \grave{ }(3)
(endm)
```

This type negation, when coupled with bottom up binding variables, can be very expressive. Since variables are initially bound in a specific observation, the observation itself will only ever provide bindings for the arguments that fall within a limited range. This characteristic inherently limits the scope of the argument to a subset of types making type negation much stronger. The case of a drugstore with a drug purchase action defined as follows can be considered:

```
(def-method
  \grave{ }(buy-drugs (agent :type :elder)
    (drug :type :not :prescription))
  \grave{ }((pick-up-drug (agent :type :elder)
        (drug :type :not :prescription))
    (carry-to-checkout (agent :type :elder)
        (drug :type :not :prescription))
    (pay (agent :type :elder)
      (clerk :type :employee))))
(def-precond 2 \grave{ }(1))
(def-precond 3 \grave{ }(2))
(endm)
```

In this case, the observation of a pick-up-drug action is assumed to only have a drug bound to the second argument. Since this binding is carried along by the observation, there is no need to worry about the possibility that the second argument might be a car or a banana. It is already constrained to the family of drugs. Thus, by negating the type prescription, this already limited set of possible bindings is further restricted to the set to non-prescription drugs.

The type system functionality for the present plan recognition system is encapsulated in two classes, VAR-CLASS and VAR-TYPE-CLASS. These classes provide an interface between variables, which can have a type, and the type system that organizes and describes the types. During domain and run-time processing, query wrapper methods can be called on the variable classes. For instance, to check the compatibility of two typed variables at run time, e.g., type equality or subsumption, the VAR-TYPE-CLASS method COMPATIBLE-VAR-TYPES-P is called. That query wrapper method, in turn, queries the instantiated type system with a type-system specific query. This procedure allows a high degree of modularity as to the specific type system used since the calls that are made remain stable regardless of the underlying type system used.

In further support of modularity, domain descriptions can be used to support variables with descriptors of arbitrary complexity using the DEF-VAR-TYPE method. The variable type descriptors can be atomic or compound. In the case of a compound variable type descriptor, the entire expression between two enclosing parenthesis is used in the variable type query. Whatever the complexity of the type descriptor, it may be used in totality in the variable query wrapper method calls to the instantiated type system.

The type system may be instantiated during a domain load. One file, TYPESYS.LISP, may be used to contain a keyword-type system load file path mapping. The type system keyword is then invoked with a call to the function USING-TYPESYS to indicate the type system to be used. When variable type queries are made, a check is done to a global variable *TYPESYS* to determine which type system is in use. This check ensures the appropriate wrapper query for that type system is made.

Typed arguments are stored in the plan library in association with the actions that enable the plans.

Like typed arguments to an observation that can be used to rule out possible explanations, temporal constraints can be very effective in pruning possible explanations. Many tasks have simple temporal relations between their subtasks, and no plan recognition system should consider as valid explanations that violate these bounds.

A duration constraint captures the overall duration for a single action. For example, most people would not take more than an hour to make lunch. This idea can be coded into the rules for recognizing “normal lunch events,” and if an agent violates this requirement, the plan recognition system should not recognize this as a normal lunch event. It may be that the lunch plan has been abandoned or it may be a special occasion, but in either case the plan recognition system should not consider this action as a normal lunch event. This kind of limitation can be captured by a simple restriction on the definition of the lunch action that requires that it not take longer than an hour to make lunch.

If duration constraints are placed on actions that have sub-actions, this placement can actually force the sub-actions to overlap. For example, in the case of an action that has three sub-actions where the parent action is constrained to take no more than 3 time units, the sub-actions either must be overlapped in time or the explanation is inconsistent if any of the actions takes longer than one time unit.

Inter-sibling temporal constraints constrain the temporal distance between the beginning and/or the end of two sibling actions. For example, in the case of starting a car by turning the ignition key and depressing the gas, if the gas is not depressed within a short proximity of the beginning of the key turning action the car will not start. In this case, a temporal constraint is needed between the start times of the two sibling actions. Again if both of these actions are seen but they are not in the correct temporal relation, no consideration should be given to any explanation of the actions that ascribes them to a car starting goal.

By specifying these constraints on the basis of the beginning and/or end times for the actions, for ordered actions, a maximum time duration can be implicitly defined for one or both of the actions. For example, in the case of two siblings α and βthat are sequentially ordered, if a constraint is added such that β_{end} must be within 5 time units of α_{begin} then both α and β must each individually be less than 5 time units and there sum must also less than 5 time units.

In one implementation, both duration and inter-sibling constraints are representable as follows:
timePoint₁<=timePoint₂+C
where the time points in the case of a duration constraint are the begin time and/or end time of some action, and in the case of an inter-sibling constraint they are the begin time or end time from two actions that are siblings in an action definition. It is this restriction that allows us to enforce that our temporal constraints will form a simple temporal problem (STP) and will, therefore, admit relatively efficient solution. If other forms are used, the temporal reasoning required may be more computationally expensive and will increase the runtime of the algorithm.

The following definitions taken from a plan library for a simple domain make use of temporal constraints:

```
(def-var-type :melts)
(def-var-type :rigid)
(def-var-type :liquid)
(def-var-type :container)
(def-root \grave{ }eat-soggy-cereal 0.5)
(def-method \grave{ }(eat-soggy-cereal (cereal :type :rigid))
  \grave{ }((pour (cereal :type :rigid) (bowl :type :container))
    (pour (milk :type :liquid) (bowl :type :container))
    (eat-from (bowl :type :container))))
(def-precond 2 \grave{ }(1))
(def-precond 3 \grave{ }(2))
;;; gotta wait at least 10 ticks
(def-temporal-greaterthan :end 2 :begin 3 10)
(endm)
(def-root \grave{ }eat-crunchy-cereal 0.5)
(def-method \grave{ }(eat-crunchy-cereal (cereal :type :rigid))
  \grave{ }((pour (cereal :type :rigid) (bowl :type :container))
    (pour (milk :type :liquid) (bowl :type :container))
    (eat-from (bowl :type :container))))
(def-precond 2 \grave{ }(1))
(def-precond 3 \grave{ }(2))
;;; gotta eat it right away
(def-temporal-lessthan :end 2 :begin 3 10)
(endm)
(def-leaf \grave{ }pour \grave{ }(“cereal or milk” “container”) 0.50 nil)
(def-leaf \grave{ }eat-from \grave{ }(“container”) 0.50 nil)
```

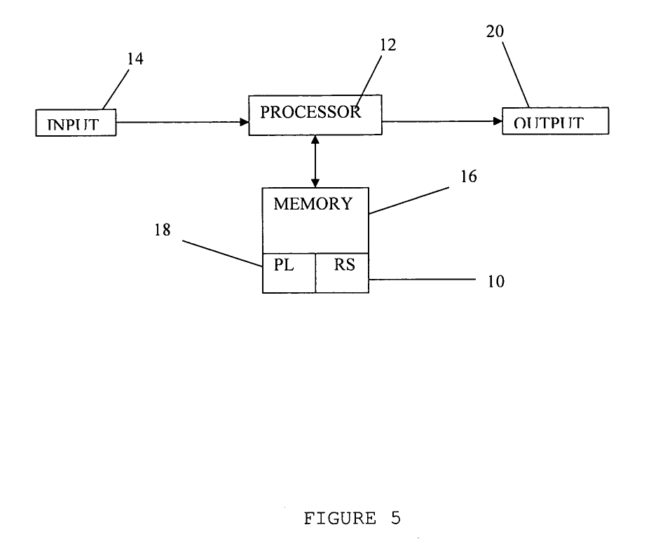

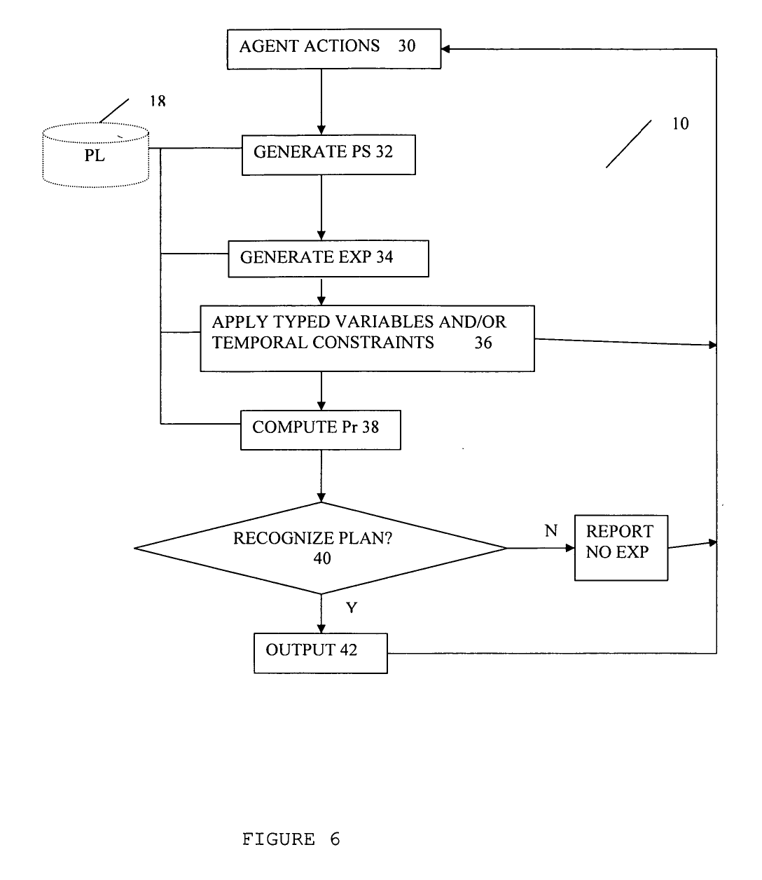

A plan recognition system 10 as described herein can be used in a wide variety of applications. For example, as shown in FIG. 5, the plan recognition system 10 can be executed by a processor 12 that takes in observations of an observed agent through an input 14 such as a keyboard, mouse, or other device. The plan recognition system 10 is stored in a memory 16 accessible for execution by the processor 12, and the plan recognition system 10 monitors various actions of an agent in order to determine the plans of the observed agent. In order to determine these plans, the plan recognition system 10 accesses a plan library 18 that is also stored in the memory 18 and that contains various plans such as those described above. The plan recognition system 10, during execution, builds pending sets by comparing the actions of the agent as input into the processor 12 to the plans stored in the plan library 18, and determines probable explanations that are consistent with the pending sets. The plan recognition system 10 and the plan library 18 that is stored in the memory 16 is described below in relation to a flow chart shown in FIG. 6. The plan recognition system 10 processes the actions of the agent in a manner dependent upon the domain in which the plan recognition system 10 is being used in order to provide an output 20 useful to the user of the plan recognition system 10. This output could be various alarms, various control actions, various reports such as a report of possible plans that the user might want to investigate further, etc.

The plan library 18, which may be in the form of a database or other data structure, is used by the plan recognition system 10 during its execution. The plan library 18 may be constructed in accordance with Definitions 1-5 for a specific domain(s) of interest to the user of the plan recognition system 10 and may be constructed in accordance with the declarations, typed variables, temporal constraints, etc. described above. For example, FIG. 1 shows a simple plan library in graphical form that may be constructed for the computer security domain. More elaborate plan libraries or plan libraries for this or other domains can be constructed in accordance with these definitions depending upon the desires of the user of the plan recognition system 10.

During execution of the plan recognition system 10 shown by way of the flow chart of FIG. 6, the various observed actions of the agent are input to the plan recognition system 10 at a block 30 one at a time in order of their occurrence. At a block 32, the plan recognition system 10 generates a pending set based on the latest action observed at the block 30. This pending set is generated in accordance with Definitions 6 and 7 based on the plans stored in the plan library 18. At a block 34, the plan recognition system 10, on the basis of this pending set and the plans stored in the plan library 18, builds new explanations and/or extends existing explanations based on Definition 8.

At a block 36, the typed variables stored in the plan library 18 are applied to the explanations such that any of the explanations that do not satisfy the typed variables are discarded. Additionally or alternatively, the temporal constraints stored in the plan library 18 are applied to the explanations such that any of the explanations that do not satisfy the temporal constraints are discarded. Alternatively, instead of discarding explanations that do not satisfy the typed variables and/or the temporal constraints, the pending sets and/or the explanations may be generated in accordance with the typed variables and/or temporal constraints. In this alternative, the block 36 would be folded into the block 32 and/or the block 34.

If there are more observations to be processed the system loops back to the block 30 and processes the next of the agent's observed actions. If there are no more input observations (e.g., such as where the system has processed all of the observations that the user specified should be included in this session), the system continues on to the block 38.

At the block 38, the plan recognition program 28 computes a probability for each of the existing explanations. These probabilities are generated at the block 38 in accordance with Definitions 9-10. Thus, the probability computed for an explanation e is based on the prior probability given in the plan library for the root goal of explanation e for the observed actions of the agent, the number of alternative rules that could be used to expand a particular one of the J choice points within explanation e, and the number of pending sets of explanations at time k. In essence, this probability indicates the likelihood that the explanation indicates the actual plan of an agent based on the agent's observed actions.

At a block 40, the plan recognition program 28 determines whether any explanations have corresponding computed probabilities that are greater than a selected value. This selection requires consideration of only those explanations that are deemed to be sufficiently important as determined by the selected value. Alternatively, all explanations can be selected and ranked according to their computed probabilities. This selection permits consideration of all explanations in order of these computed probabilities. As another alternative, only the explanation having the highest computed probability may be selected. This selection requires consideration of only that explanation which is deemed most likely to fit the observed actions. Those explanations selected at the block 40 are provided at the block 42 as the output 18.

If the plan recognition system 10 determines at 40 that there are no explanations having corresponding computed probabilities that are greater than a selected value, the plan recognition system 10 reports at 42 that it was unable to explain the observations. The system's set of explanations is reset and flow returns to 30 to receive a new set of observations to process. Likewise after the pertinent identified explanations are output at 42, the system's set of explanations is reset and flow returns to 30 to receive more observed actions for processing.

Certain modifications of the present invention have been discussed above. Other modifications will occur to those practicing in the art of the present invention. For example, a plan library fitting a particular domain is constructed as described above in accordance with Definitions 1-5. Instead, the plan library may be constructed in accordance with other definitions suitable to the chosen domain.

As another example, pending sets are constructed as described above in accordance with Definitions 6 and 7 and explanations are constructed as described above in accordance with Definition 8. Instead, pending sets and explanations may be constructed in accordance with other definitions.

As still another example, probabilities are computed as described above in accordance with Definitions 9-10. Instead, probabilities may be constructed in accordance with other definitions.

Moreover, as described above, plan recognition is based primarily on observed actions of an agent. Other factors, however, may be used in plan recognition. For example, as disclosed in U.S. patent application Ser. Nos. 10/303,223 and 10/348,264 mentioned above, user classification, anomaly detection, and authentication can be used to assist in plan recognition. User classification and anomaly detection continuously monitors a user's actions in order to identify and classify the user based on a learned pattern of actions characterizing the user and based on anomalies in a user' actions. For example, users have typing and pointing styles that involve such characteristics as typing rate, typing rhythm, typing errors, click rate, click rhythm, click errors, etc. Also, users have certain patterns of interaction with computers (such as the order in which applications are usually accessed) that can be learned and associated with corresponding users. User authentication, for example, can involve the use of passive biometrics to identify a user. Such passive biometrics, for example, can include face recognition identification, fingerprint identification, voice recognition identification, and/or stress detection through acoustic, visual and/or infrared sensing. Passive biometrics may also include retina and/or iris scans. Additionally or alternatively, active recognition may be employed for user authentication. For example, the user may be directed to enter a pass word, a personal identification number, personal information, a fingerprint through use of a peripheral device, a signature, hand geometry, etc. Such direction may be random, periodic, and/or directed such as when the plan recognition system 10 determines that a user is suspicious.

Also, as shown in FIG. 5, the plan recognition system 10 is used to monitor an agent's use of the processor 12. The plan recognition system 10 can also be arranged to monitor other actions of an agent such as the use by the agent of other equipment and/or any type of process. Indeed, the plan recognition system 10 can be used to monitor any actions of an agent.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A plan recognition method, implemented by a processing system, of recognizing a plan based on observed actions comprising:
reading the observed actions of at least one agent;
based on the observed actions and a plan library, generating a pending set of actions that are pending execution by the agent and generating explanations for the pending actions contained in the pending set, wherein the plan library contains plans, wherein the plans stored in the plan library include typed variables, and wherein the explanations depend on the typed variables;
computing probabilities as to the likelihood that the explanations represent at least one actual plan of the agent; and,
recognizing at least one of the explanations as the actual plan of the agent based on the computed probabilities.

2. The method of claim 1 wherein the generating of a pending set of pending actions based on the observed actions includes:
comparing the observed actions with actions contained in the plans stored in a plan library; and,
forming the pending sets based on yet-to-be-observed actions corresponding to the plans stored in the plan library that have actions enabled by the observed actions.

3. The method of claim 1 wherein the computing of probabilities comprises computing the probabilities as a function of (i) prior probabilities associated with root goals of plans corresponding to the generated explanations, (ii) the number of alternative courses of action available to the agent in the generated explanations, and (iii) the number of elements in the generated pending set.

4. The method of claim 1 wherein at least one of the typed variables has a type defined by negation.

5. The method of claim 1 wherein the generating of a pending set of pending actions based on the observed actions includes comparing the observed actions with actions contained in the plans stored in a plan library, and wherein the actions contained in the plans stored in the plan library include temporal constraints between actions.

6. The method of claim 1 wherein the types variables contained in the plan library has the following form:
variable :type definition
wherein variable represents any variable in the plan library, wherein :type indicates that the preceding variable is a typed variable, and wherein definition is a definition of the type.

7. A plan recognition method, implemented by a processing system, of recognizing a plan based on observed actions comprising:
reading the observed actions of at least one agent;
based on the observed actions and a plan library, generating a pending set of actions that are pending execution by the agent and generating explanations for the pending actions contained in the pending set, wherein the plan library stores plans, wherein the plans contain actions, wherein the actions contained in the plans stored in the plan library include temporal constraints between actions, and wherein the explanations depend on the temporal constraints;
computing probabilities as to the likelihood that the explanations represent at least one actual plan of the agent; and,
recognizing at least one of the explanations as the actual plan of the agent based on the computed probabilities.

8. The method of claim 7 wherein the generating of a pending set of pending actions based on the observed actions includes:
comparing the observed actions with actions contained in the plans stored in a plan library; and,
forming the pending sets based on yet-to-be-observed actions corresponding to the plans stored in the plan library that have actions enabled by the observed actions.

9. The method of claim 7 wherein the computing of probabilities comprises computing the probabilities as a function of (i) prior probabilities associated with root goals of plans corresponding to the generated explanations, (ii) the number of alternative courses of action available to the agent in the generated explanations, and (iii) the number of elements in the generated pending set.

10. The method of claim 7 wherein at least one of the typed variables has a type defined by negation.

11. The method of claim 7 wherein the generating of a pending set of pending actions based on the observed actions includes comparing the observed actions with actions contained in the plans stored in a plan library, and wherein the actions contained in the plans stored in the plan library include temporal constraints between actions.

12. The method of claim 7 wherein the temporal constraints contained in the plan library has the following form:
def-temporal relation operator x operator y z
wherein relation is greater than or less than indicating temporal precedence, wherein operator is either :begin or :end, wherein operator x is the beginning or end of action x in the plan library, wherein operator y is the beginning or end of action y in the plan library, and wherein z represents an offset.

13. A computer readable storage medium having program code stored thereon which, when executed, performs the following plan recognition functions:
reading the observed actions of at least one agent;
comparing the observed actions to plan actions contained in plans stored in a plan library;
generating explanations for the observed actions based on the comparison of the observed actions to plan actions, wherein the explanations must satisfy typed variables and temporal constraints stored in the plan library;
selecting at least one of the explanations as a best fit for the observed actions; and,
providing an output based on the selected explanation.

14. The computer readable storage medium of claim 13 wherein the program code, when executed, performs the additional function of removing one of the explanations based on a failure to observe an action that is an element of the removed explanation.

15. The computer readable storage medium of claim 13 wherein the typed variable has a type defined by negation.

16. The computer readable storage medium of claim 13 wherein the types variables contained in the plan library has the following form:
variable :type definition
wherein variable represents any variable in the plan library, wherein :type indicates that the preceding variable is a typed variable, and wherein definition is a definition of the type.

17. The computer readable storage medium of claim 13 wherein the temporal constraints contained in the plan library has the following form:
def-temporal relation operator x operator y z
wherein relation is greater than or less than indicating temporal precedence, wherein operator is either :begin or :end, wherein operator x is the beginning or end of action x in the plan library, wherein operator y is the beginning or end of action y in the plan library, and wherein z represents an offset.

18. The computer readable storage medium of claim 17 wherein the types variables contained in the plan library has the following form:
variable :type definition
wherein variable represents any variable in the plan library, wherein :type indicates that the preceding variable is a typed variable, and wherein definition is a definition of the type.

19. A plan recognition method, implemented by a processing system, of recognizing a plan based on observed actions comprising:
reading the observed actions of at least one agent;
comparing the observed actions to a plan library contains possible plans of the agent, wherein the plans stored in the plan library include typed variables or temporal constraints relating to statements in the plans; and,
recognizing a plan of the agent based on the comparing of the observed actions to the plan library and on the typed variables or temporal constraints.

20. The method of claim 19 wherein the types variables contained in the plan library has the following form:
variable :type definition
wherein variable represents any variable in the plan library, wherein :type indicates that the preceding variable is a typed variable, and wherein definition is a definition of the type.

21. The method of claim 19 wherein the temporal constraints contained in the plan library has the following form:
def-temporal relation operator x operator y z
wherein relation is greater than or less than indicating temporal precedence, wherein operator is either :begin or :end, wherein operator x is the beginning or end of action x in the plan library, wherein operator y is the beginning or end of action y in the plan library, and wherein z represents an offset.

22. The method of claim 21 wherein the types variables contained in the plan library has the following form:
variable :type definition
wherein variable represents any variable in the plan library, wherein :type indicates that the preceding variable is a typed variable, and wherein definition is a definition of the type.

23. The method of claim 19 wherein the plan library includes both typed variables and temporal constraints relating to statements in the plans.

24. The method of claim 23 wherein the types variables contained in the plan library has the following form:
variable :type definition
wherein variable represents any variable in the plan library, wherein :type indicates that the preceding variable is a typed variable, and wherein definition is a definition of the type.

25. The method of claim 23 wherein the temporal constraints contained in the plan library has the following form:
def-temporal relation operator x operator y z
wherein relation is greater than or less than indicating temporal precedence, wherein operator is either :begin or :end, wherein operator x is the beginning or end of action x in the plan library, wherein operator y is the beginning or end of action y in the plan library, and wherein z represents an offset.

26. The method of claim 25 wherein the types variables contained in the plan library has the following form:
variable :type definition
wherein variable represents any variable in the plan library, wherein :type indicates that the preceding variable is a typed variable, and wherein definition is a definition of the type.
